(19) United States
(12) Patent Application Publication
(10) Pub. No.: US 2019/0124912 A1
(43) Pub. Date: May 2, 2019

(54) LIVE-RELEASE ANIMAL TRAP THAT SPLITS INTO MULTIPLE SECTIONS

(71) Applicant: Talmet Industries Inc., Calgary, CA (US)

(72) Inventor: Peter Talbot, Calgary (CA)

(21) Appl. No.: 16/159,830

(22) Filed: Oct. 15, 2018

Related U.S. Application Data
(60) Provisional application No. 62/577,782, filed on Oct. 27, 2017.

(51) Int. Cl. A01M 23/20

(52) U.S. Cl. CPC A01M 23/20

(57) ABSTRACT

An animal trap contains multiple tubular sections connected with side latches to form a single hollow structure. A trigger mechanism includes a curved wobble plate with curvature matching a rear tube section. When stepped on by an animal, the curved wobble plate pulls a trigger pin from a trap door causing the door to fall to the ground. A rotatable door latch then moves into a locked position preventing the door from opening. After determining the trap to contain an animal, a trapper transports the trap to a remote location. A pull rope is connected to at least one of the sections, and another section may be anchored to the ground using anchor pins. The trapper undoes the side latches and rotates the door latch into an unlocked position. The trapper removes the door from the trap and pulls the trap sections apart thereby releasing the animal from the trap.

### CROSS-REFERENCE TO RELATED APPLICATIONS

This application claims the benefit of priority of U.S. Provisional Application No. 62/577,782 filed Oct. 27, 2017, which is incorporated herein by reference.

### BACKGROUND OF THE INVENTION

### (1) Field of the Invention

The invention pertains generally to animal trapping. More specifically, the invention relates to a trap for catching an animal such as a skunk at a first location and quickly releasing the animal at a second location.

### (2) Description of the Related Art

Animal trapping involves utilizing an apparatus called a trap to capture an animal. Different animals may be trapped for different reasons including but not limited to for food, fur collection, wildlife management, and pest control.

The skunk is an example of an animal that is generally viewed by property owners as an unwanted guest. Although people do not want skunks on their property, most people do not wish to harm the skunk and would prefer to simply relocate the skunk to a more suitable environment. Relocation of skunks typically involves the use of humane-capture and live-release traps. The property owner may obtain the traps and perform the trapping and relocation process themselves, or the owner may engage the services of a professional pest control company. The relocation process typically involves setting one or more traps on the property, waiting for a skunk to be caught in a trap, transporting the skunk within the trap to a new location, placing the trap on the ground at the new location, opening the trap door, and retreating to a safe location to wait for the animal to leave the trap.

There are several problems with current skunk traps and associated live-release relocation techniques.

During release, skunks can remain in opened traps for up to twelve hours before feeling safe enough to leave. After release, skunks may even return to the trap for safety if scared. For pest control companies, lengthy release time results in expensive non-billable hours and fuel costs. Waiting for a skunk to leave the trap is problematic as it costs the company downtime and fuel while the technician is waiting in an air-conditioned or heated vehicle. Pest control technicians generally collect multiple skunks from calls in the morning, load them into their trucks, and, if doing live release, release them all together. One reluctant animal can cost company hours off the clock because most jobs are billed flat-rate. One-off calls during mid-day to collect animals pose a greater financial risk to companies as they now chance lower profits per skunk because they must wait for a single animal to exit the trap. Leaving expensive traps unattended during the release process is also undesirable and may result in fines in locations where such behavior is not permitted. There is concern that some pest control companies may 0 animals to avoid costs associated with lengthy wait times instead of performing the as-advertised live release.

For property owners and DIYers, the reluctance of a skunk to leave the trap significantly complicates early morning animal release. This demographic wants to avoid the expensive costs associated with professional skunk removal ($200 per animal and up to seven kits per den). However, just as important, these people often have work or other commitments and cannot afford to wait for the skunk to decide to leave a traditional trap while the person sits in a vehicle on a roadside. For DIYers and property owners who are on their way to work, time is money. DIYers also want this part of the process to be fast as they may be uncertain of local ordinances or fearful of attracting the attention of adjacent landowners at the remote release location.

To speed up the release process, some people actively encourage the skunk to the leave the trap by various means. Amateurs and professionals alike have kicked or thrown stones at traps, rolled traps upside down, reached into the trap, or improvised strings to the end of traps to jostle the skunk and encourage it to leave. Videos exist on YouTube® of people in close proximity to traps encouraging skunks to exit with loud noises and aggressive motions. Some are successful; others get sprayed. Individuals have been known to hold a trap upside down and shake it to get the skunk to leave. However, if not released in a proper manner and location, skunks with their inherently poor eyesight are just as likely to run towards the human as away. Besides the risk of getting sprayed, proximity of the human to the animal may lead to more dangerous situations such as the impatient person getting scratched or bitten.

### BRIEF SUMMARY OF THE INVENTION

To overcome the above-identified problems, it is object of some embodiments of the invention to provide an animal trap that splits into multiple sections during the live-release process in order to encourage the animal to quickly leave the trap.

According to an exemplary embodiment of the invention there is disclosed an animal trap including a first hollow structural section having a door and a first open end, a second hollow structural section having a second open end, and a side latch on at least one of the first hollow structural section and the second hollow structural section. The side latch is operable by a user to selectively secure the first open end of the first hollow structural section to the second open end of the second hollow structural section. When secured together by the side latch, the first hollow structural section and the second hollow structural section are joined and form a single hollow structure. The door is movable between an open position allowing an animal to enter the single hollow structure through the door, and a closed position preventing the animal from exiting the single hollow structure through the door. The door is automatically triggered to move from the open position to the closed position after the animal has entered the single hollow structure. When not secured together by the side latch, the first open end and the second open end may be pulled apart from one another thereby allowing the animal to exit the animal trap through one of the first and second open ends.

According to an exemplary embodiment of the invention there is disclosed a method of relocating an animal. The method includes positioning bait within at least one hollow section of an animal trap, connecting at least two hollow sections of a trap together in series to form a single hollow section, setting a door in an open position thereby allow an animal to enter the trap at a first location, returning to the trap at a later time, and determining that there is an animal captured within the trap. The method further includes transporting the trap containing the animal to a second location for release, and during the release process, separating the at least two hollow sections of the trap apart from one another.

An advantage of some embodiments of the invention is that time waiting for a skunk to leave the confines of the trap during the live-release process is reduced when compared to traditional traps.

An advantage of some embodiments of the invention is that pest control companies can enhance reputation and market share by advertising humane release as opposed to just humane capture.

An advantage of some embodiments of the invention is that the trap has the ability to separate into multiple sections, creating additional points of exit for the animal.

An advantage of some embodiments of the invention is that the trap has a remote mechanical method of safely releasing the animal from a remote distance.

An advantage of some embodiments of the invention is that the trap has a curved wobble plate that maximizes force on the trigger pin within a curved, i.e., tubular, trap.

An advantage of some embodiments of the invention is that the trap allows a single-handed door release for the protection and safety of the user. The trap in some embodiments incorporates a door latch release mechanism that both automatically locks the door closed upon door trigger and that stays in position in an unlocked position when desired by a user to facilitate single handed door removal.

An advantage of some embodiments of the invention is that the trap has an adjustable door pivot for preventing door jams and door activations due to false wind triggers.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a perspective view of a skunk trap according to an exemplary embodiment of the invention.

FIG. 2 illustrates a perspective view of the front end of the first tube section of FIG. 1.

FIG. 3 illustrates a perspective view of the trigger pin sleeve according to an alternative embodiment.

FIG. 4 illustrates a close-up perspective view of a door latch of the trap of FIG. 1 in a neutral position at the top of the door frame member.

FIG. 5 illustrates an example of the door latch of FIG. 4 rotated fully forward into the unlocked position.

FIG. 6 illustrates a perspective view of a wobble plate within the second tube section of FIG. 1 for automatically triggering the removal of the trigger pin from the trigger pin hole in response to movement of an animal within the trap.

FIG. 7 illustrates a perspective view into the hollow section of the second tube section of FIG. 6 showing the wobble plate lifted upwards at the end opposite the bolt thereby positioning the wobble plate in a set position.

FIG. 8 shows a perspective view of the end plate of the trap of FIG. 1.

FIG. 9 shows a perspective view of the door installed in the front end of the first tube section of FIG. 1.

FIG. 10 illustrates the trap of FIG. 1 after the second section has been pulled apart from the first section exposing lateral support pins according to an exemplary embodiment.

FIG. 11 illustrates the trap of FIG. 1 having a hinge on one side instead of a side latch thereby allowing the trap to split apart in a folding manner.

FIG. 12 illustrates door bumpers installed on the door frame bottom member according to an exemplary embodiment.

FIG. 13 illustrates a perspective view of the trigger pin being inserted into the trigger pin hole with an orientation to increase sensitivity according to an exemplary embodiment.

FIG. 14 illustrates a perspective view of the trigger pin being inserted into the trigger pin hole with an orientation to decrease sensitivity according to an exemplary embodiment.

FIG. 15 illustrates an animal trap that separates horizontally according to an exemplary embodiment.

FIG. 16 illustrates the animal trap of FIG. 15 after the user has pulled away the lid section.

FIG. 17 illustrates an animal trap that splits in two and also includes hinged top sections that automatically open after the trap is split in two according to an exemplary embodiment.

FIG. 18 illustrates the animal trap of FIG. 17 with the panel sections opened.

FIG. 19 illustrates an animal trap that splits into multiple sections and is manufactured with a diagonal split line according to an exemplary embodiment.

FIG. 20 illustrates the animal trap of FIG. 19 after the first and second sections are pulled apart from one another.

FIG. 21 illustrates an animal trap that splits into two sections with a polygon split line according to another exemplary embodiment.

FIG. 22 illustrates an animal trap having multiple sections supported by arches according to an exemplary embodiment.

FIG. 23 illustrates the animal trap of FIG. 22 while the first and second sections are separated from one another.

FIG. 24 illustrates the door pivot of FIG. 9 while extended to temporarily block the trap door from opening such as during transport according to an exemplary embodiment.

FIG. 25 is a forward-facing view of an animal trap illustrating door bumpers installed on the door frame side members according to an exemplary embodiment.

FIG. 26 is a rearward-facing view of the animal trap of FIG. 25 illustrating the door bumpers installed on the door frame side members.

### DETAILED DESCRIPTION

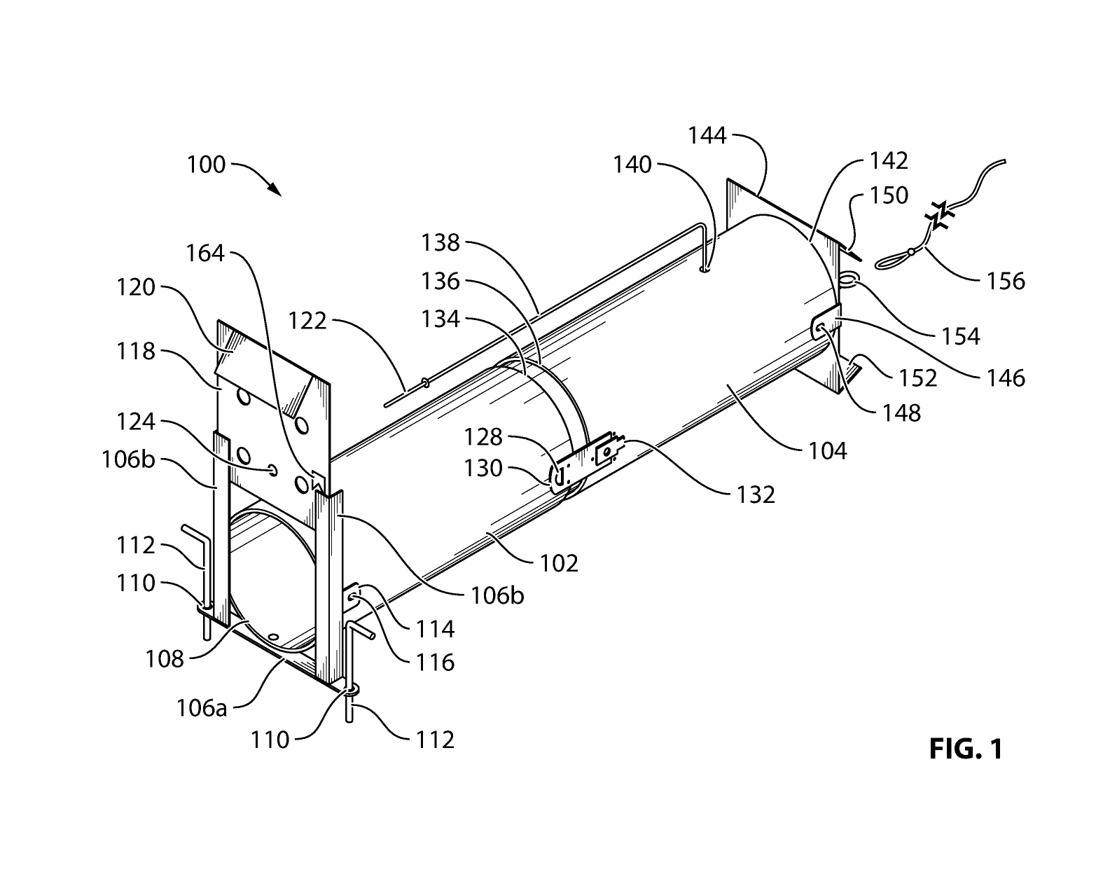

FIG. 1 shows a perspective view of a skunk trap 100 according to an exemplary embodiment of the invention. The skunk trap 100 includes a first hollow tube section 102 and a second hollow tube section 104. A front door frame 106 is mounted to a front end 108 of the first tube section 102. The bottom frame member 106a of the door frame 106 includes anchor holes 110 through which anchor pins 112 may be inserted to secure the first tube section 102 to a desired location on the ground. Side frame members 106b of the front door frame 106 are secured to the front end 108 of the first tube section 102 by side tabs 114 and screws 116 located and affixed approximately at the middle height of the first tube section 102.

A door 118 slides up and down within tracks formed on the side frame members 106b. The door 118 includes a folded downward section that acts as an integrated handle 120. The door 118 may be completely removed from and re-inserted into the top of the tracks formed by the side frame members 106b by a user. The door 118 is shown in the open position in FIG. 1 and the door can be held in the open position by a trigger pin 122 inserted into a trigger pin hole 124 on the door 118 to allow an animal to enter the trap 100. Removal of the trigger pin 122 from the trigger pin hole 124 causes the door 118 to fall downward along the tracks of the door side frame members 106b into a closed position under the force of gravity. When the door 118 is in the closed position, the door 118 blocks the front end 108 and prevents an animal inside the trap 100 from existing via the front end 108 of the first tube section 102.

A first side latch 126 is used to attach the first tube section 102 to the second tube section 104 and may provide structural support holding these two sections 102, 104 together. The side latch 126 includes a latch catch 128 mounted on the first tube section 102 and a latch loop 130 mounted on the second tube section 104. The latch loop 130 can be placed over the latch catch 128 by the user and tightened utilizing a lever 132 to securely join the first and second tube sections 102, 104 together. Likewise, the user may also loosen the lever 132 and remove the latch loop 130 from the latch catch 128 in order to detach and separate the first tube section 102 from the second tube section 104. The lever 132 may be spring loaded to facilitate locking and unlocking actions by the user.

Although not visible in FIG. 1, in this embodiment there is a second side latch 126 of similar structure provided on the other side of the tube sections 102, 104. The dual side latches 126 allow the user to join an open back end 134 of the first tube section 102 to an open front end 136 of the second tube section 104. When secured together by the side latches 126, the joined tube sections 102, 104 form a single hollow tube structure of trap 100 through which an animal can move. Any number of side latches 126 may be provided in different embodiments to provide required lateral support and strength.

The trigger pin 122 is coupled to a trigger line 138 which enters the second tube section 104 via a trigger line hole 140 positioned on the top of the second tube section 104 near the back end 142. The back end 142 of the second tube section 104 is covered by an end plate 144, which prevents an animal inside the trap 100 from exiting via the back end 142. The end plate 144 is attached to the second tube section 104 utilizing side tabs 146 and screws 148. Atop portion of the end plate 144 is bent downward to provide a handle 150 and a bottom portion of the end plate 144 is bent upwards to form a skid plate 152. A pull rope eyelet 154 is attached to the end plate 144, and a pull rope 156 of a desired length such as twenty-five yards is attached to the eyelet 154.

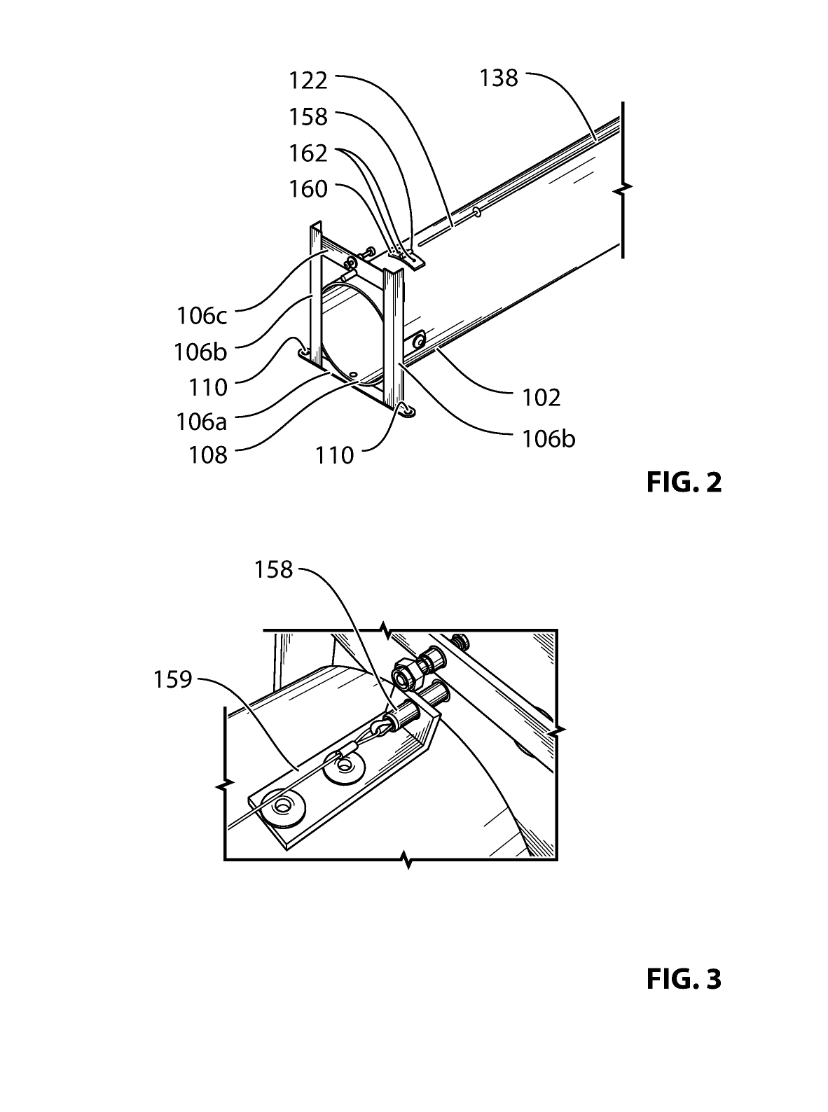

FIG. 2 illustrates a perspective view of the front end 108 of the first tube section 102 of FIG. 1. In FIG. 2, the door 118 has been removed by a user sliding the door 118 upward and out of the tracks formed by the door frame side members 106b. A trigger pin sleeve 158 is secured to the top center of the first tube section 102 near the front end 108 by a curved supporting plate 160 and screws 162. The trigger pin sleeve 158 positions the trigger pin 122 to ensure that the trigger pin 122 is inserted into the trigger pin hole 124 on the door 118 while the door in in the open position in order to hold the door 118 in the open position as shown in FIG. 1.

FIG. 3 illustrates a perspective view of the trigger pin sleeve 158 according to an alternative embodiment. Unlike in the embodiment of FIG. 2, in FIG. 3 the trigger pin sleeve 158 is mounted on an L-bracket 159, which may be easier to manufacture, be more reliable (reduce points of failure), and lend itself better to better to galvanizing, powder coating, or passivation.

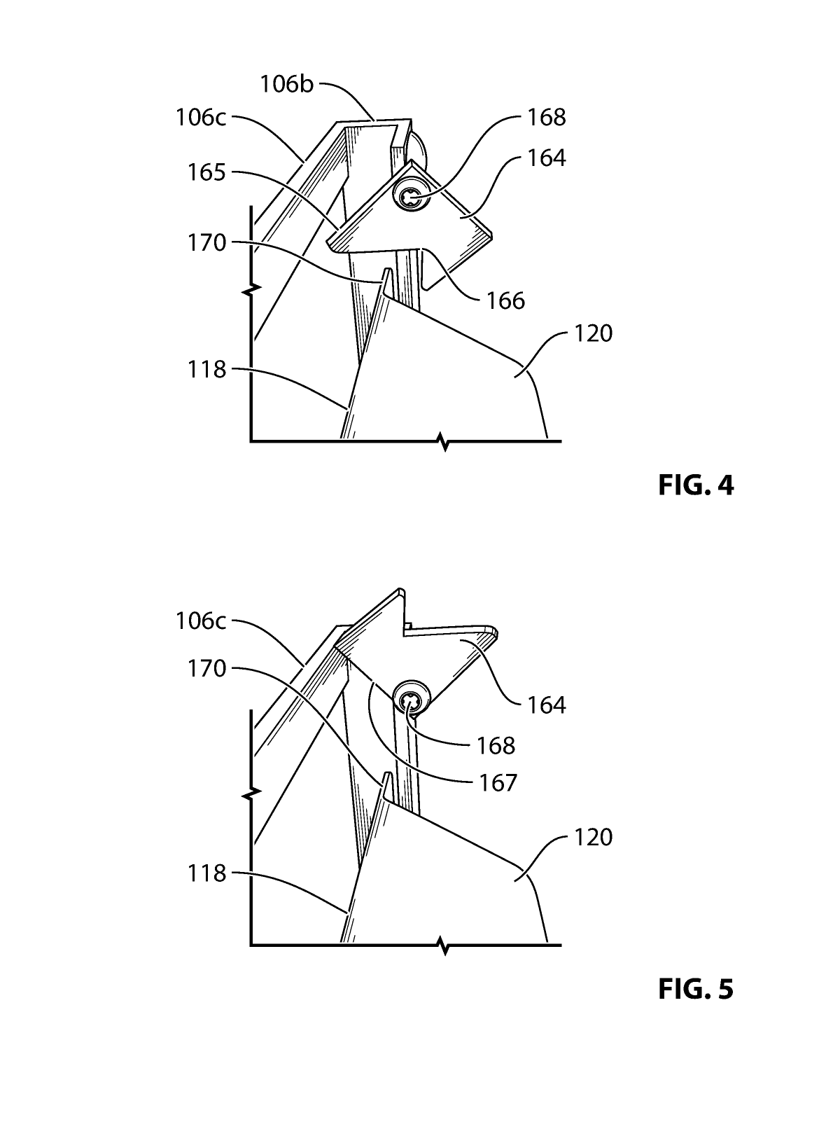

FIG. 4 illustrates a close-up perspective view of a door latch 164 in a neutral position at the top of the door frame member 106b. The door latch 164 is mounted to the door frame side member 106b by a support pin 168, and the door latch 164 is rotatable around the support pin 168. The latch 164 includes a W-shaped bottom forming an open notch area 164. In the neutral position of the door latch 164 as illustrated in FIG. 4, the open notch area 166 is naturally directed toward the top edge 168 of the door 118 by the force of gravity. This happens when the door 118 is in the closed position. The door latch 164 is supported by a support pin 168 mounted to the door frame side member 106a. Because the door latch 164 is free to pivot around the support pin 168, the door latch 164 in the neutral position as illustrated in FIG. 4 allows the door 118 to be inserted and moved downward along the track formed in the door frame side member 106b. As the door 118 moves downward, the door latch 164 is rotated to a partial forward position by the side of the door 118. The door 118 is able to freely fall downward while the door latch 164 is pushed in the partial forward position until the door 118 impacts the bottom frame member 106a. For instance, the door 118 may automatically fall downward upon movement of an animal in the trap 100 causing the trigger pin 122 to be removed from the trigger pin hole 124.

After the door 118 has impacted the bottom frame member 106a (or has impacted the bumpers 196 on the bottom frame member 106a when bumpers 196 are being utilized) and the door 118 is now in the closed position, the top edge 170 of the door 118 is low enough that the door latch 164 rotates back to the neutral position under the force of gravity. While the door latch 166 is in the neutral position, the door 118 is unable to be opened because the upper edge 170 of the door will impact the open notch area 166 attempting to rotate the door latch 164 in an opposite (backwards) direction. However, the latch 164 is prevented by rotating backwards from the neutral position by the door frame upper member 106c. In this way, the door latch 164 while in the neutral position illustrated in FIG. 4 automatically locks the door 118 thereby prevent the animal in the trap 100 from being able to push the door 118 upwards in order to escape. Likewise, the door latch 164 in the neutral position helps prevent accidental release by requiring the user to perform two actions in order to open the door 118.

To open the door 118, the user manually rotates the door latch 164 in a forward direction all the way until the door latch is in an unlocked position and then pulls up on the door 118 in order to remove the door 118 from the trap 100. FIG. 5 illustrates an example of the door latch 118 rotated fully forward into the unlocked position. When the door latch 164 is in the unlocked position, the door latch 164 is balanced and stable under the force gravity while resting on the upper frame member 106c such that the user does not need to continue to hold the latch 164 in the unlocked position. In this way, opening the trap 100 may involve the user first moving the door latch(s) 164 into the unlocked position as illustrated in FIG. 5 and then pulling upward on handle 120 in order to open and remove the door 118 from the trap 100.

In some embodiments, a single door latch 164 is included on the door frame 106 to allow one-handed-release of the door 118 by a user. A typical user's fingers will be able to reach and rotate the door latch 164 while simultaneously or immediately after pulling upward on the door handle 120 in order to open and/or remove the door 118. One-handed-release may be beneficial for some users because the user will be able to position their body toward the back end 142 as far away from the front end 108 as possible. This may increase safety for the user because some animals may run out of the front end 108 as soon as the door is opened 118.

In some embodiments, multiple door latches 164 of similar structure are provided on either side of the door frame side members 106b. Although dual door latches 164 may make one-handed-release more difficult or a bit slower, having multiple door latches 164 may be beneficial in some applications to provide redundant locking mechanisms to ensure the door 118 stays in the closed position until the user deliberately opens it. Likewise, in some embodiments, the handle 120 of the door 118 is also utilized as a carrying handle for trap 100. When used in this manner, the weight of the trap 100 and any animal held therein is transferred to the handle 120 via the support pin(s) 168. Having this weight load transferred via multiple door latches 164 and their associated support pins 168 may be beneficial to support greater weight loads while carrying the trap 100 with the door handle 120.

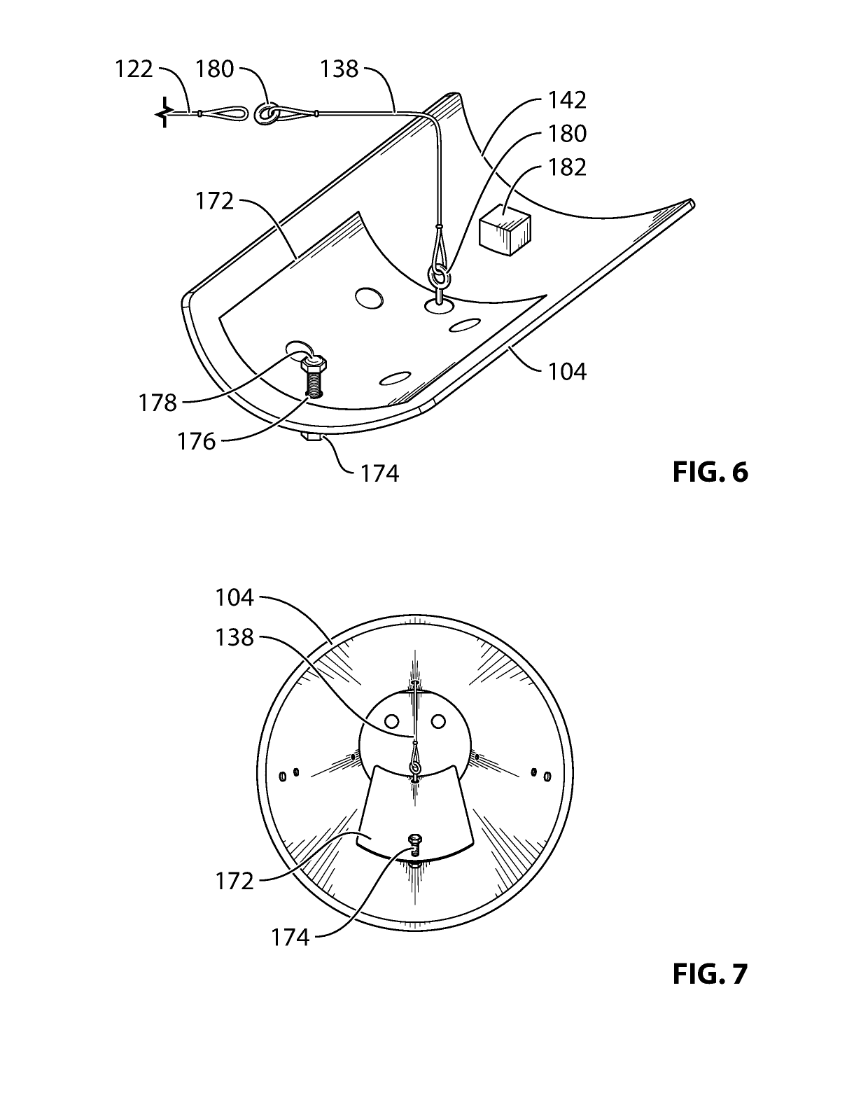

FIG. 6 illustrates a perspective view of a wobble plate 172 within the second tube section 104 for automatically triggering the removal of the trigger pin 122 from the trigger pin hole 124 in response to movement of an animal within the trap 100. The wobble plate 172 in this embodiment is a curved plate of metal with a concave curve that substantially matches the inside curvature of the second tube section 104. The wobble plate 172 is secured to the floor of the second tube section 104 by a bolt 174. A nylon insert nut 176 is intermediate the floor of the second tube section 104 and the wobble plate 172 to increase the wobbliness of the wobble plate 172. Another nut 178 is applied to the end of the bolt 174 to secure the connection.

FIG. 7 illustrates a perspective view into the hollow section of the tube section 104 showing the wobble plate 172 lifted upwards at the end opposite the bolt 174 thereby positioning the wobble plate 172 in a set position. The wobble plate 172 is lifted off the floor of the second tube section 104 in the set position by the force applied by the trigger line 138 when the trigger pin 122 is positioned within the trigger pin hole 124 and holding the door 118 in the open position. Snaps, nylon ties, swivels or other user-attachable hardware such as stainless-steel slip rings 180 are utilized to attach the trigger line 138 to the wobble plate 172 and to the trigger pin 122. The length of the trigger line 138 is preconfigured to ensure the wobble plate 172 is raised off the floor by an amount sufficient to require an animal entering the trap to climb over the wobble plate 172 in order to obtain the bait 182 placed behind the wobble plate 172.

Because the wobble plate 172 is lifted off the floor near the back end 142 of the trap opposite where the wobble plate 172 is secured to the floor by bolt 174, as an animal moves within the hollow tube towards the bait 142 near the back end 142, the animal will step on the wobble plate 172. The force of gravity on the animal's body pushes the raised end of the wobble plate 172 downward thereby pulling the trigger line 138 and removing the trigger pin 122 from the trigger pin hole 124 on the door 118. The door 118 will then fall to the closed position trapping the animal inside the trap 100.

The curved single pivot wobble plate 172 channels the animal's weight to the centre of the wobble plate 172. Like stepping on an upturned shovel in the grass, the unstable wobble plate 172 self-aligns to its pivot point 174, directing the animal's weight in such a way that maximum force is exerted on the trigger line 138, even for juvenile animals. This increases the travel of the trigger line 138, consistently releasing the door 118 to fall and secure the animal within the trap 100.

Another benefit of the curved wobble plate 172 in this embodiment is that it maximizes the available movement distance of the wobble plate 172. Flat trigger plates utilized on conventional traps are subject to the geometric limitations of placing a square shape inside a round tube: its range of motion is limited and can only be increased by reducing its dimensions. For example, the surface area of a flat plate would need to be reduced such that it could fully move up and down within the tubular structure 104, and then by elevating it closer to the centre of the tube to increase its range of motion. Decreasing the surface area of a trip plate inside a tube trap reduces its effectiveness, and raising it to the center of the trap in order to allow for sufficient movement creates an obstacle larger skunks must now choose to navigate to access the bait. More importantly, as the plate represents a lever, a shorter length of movement is detrimental both in terms of mechanical advantage (for juvenile animals), as well as the travel distance needed to trigger a door. However, the curved nature of the wobble plate 172 in the embodiment of FIG. 6 and FIG. 7 enables the wobble plate 172 to both have a large surface area while also being able to lie flat against the curved surface of the tubular section 104 thereby maximizing the distance the wobble plate 172 can move downward when stepped on by an animal.

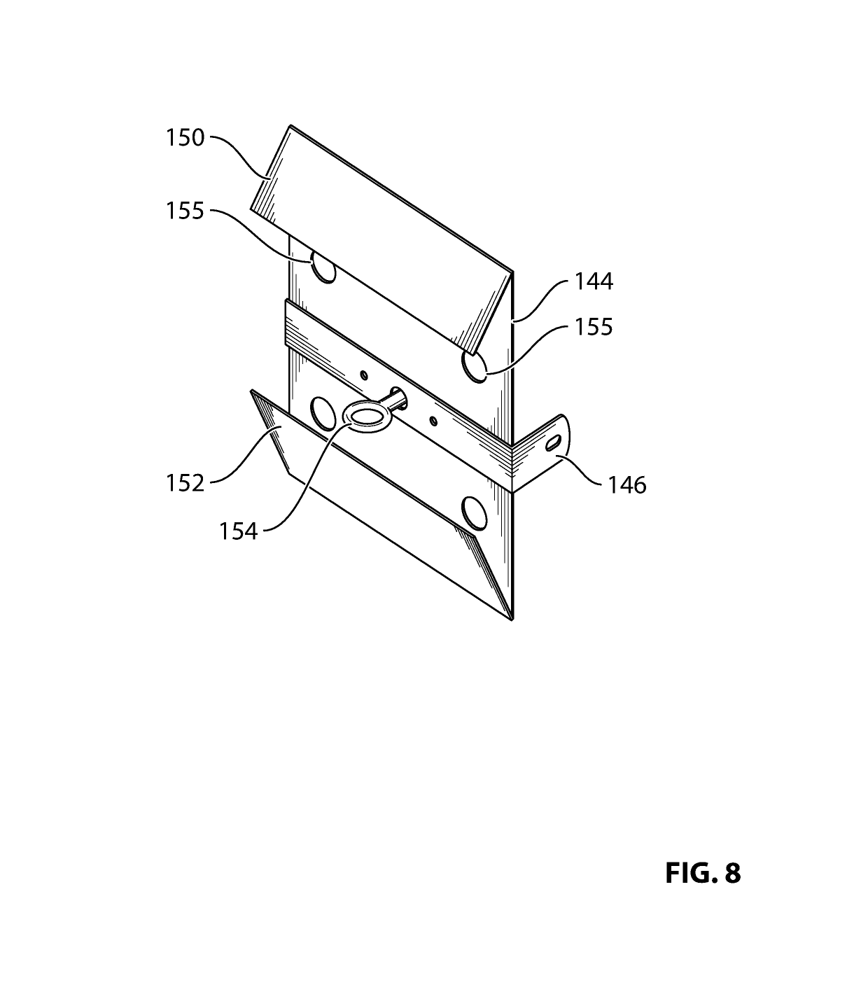

FIG. 8 shows a perspective view of the end plate 144. As illustrated, the end plate 144 includes a strip of metal forming side tabs 146 for mounting to the second tube section 104. The top portion of the end plate 144 is bent downward to provide the handle 150 and the bottom portion of the end plate 144 is bent upwards to form the skid plate 152. A pull rope eyelet 154 is attached to the end plate 144. The handle 150 may be gripped by user for carrying the trap 100 while fully assembled with an animal held therein. The skid plate 152 facilitates the movement of the second tube section 104 over the ground during live-release of the animal while the second tube section 104 is pulled away by the first tube section 102 by force exerted on a pull rope 156 attached to the pull rope eyelet 154. Holes 155 on the end plate 144 allow air flow into and out of the trap both to allow an enclosed animal to breathe but also to allow the scent of the bait 182 to escape out of the trap and encourage animals to enter. In some embodiments, the entire trap or any portion thereof may be perforated with small scent holes 155. An electric fan may also be installed to blow into the trap causing positive air pressure that results in air scented by the bait to continually flow out of the air holes 155.

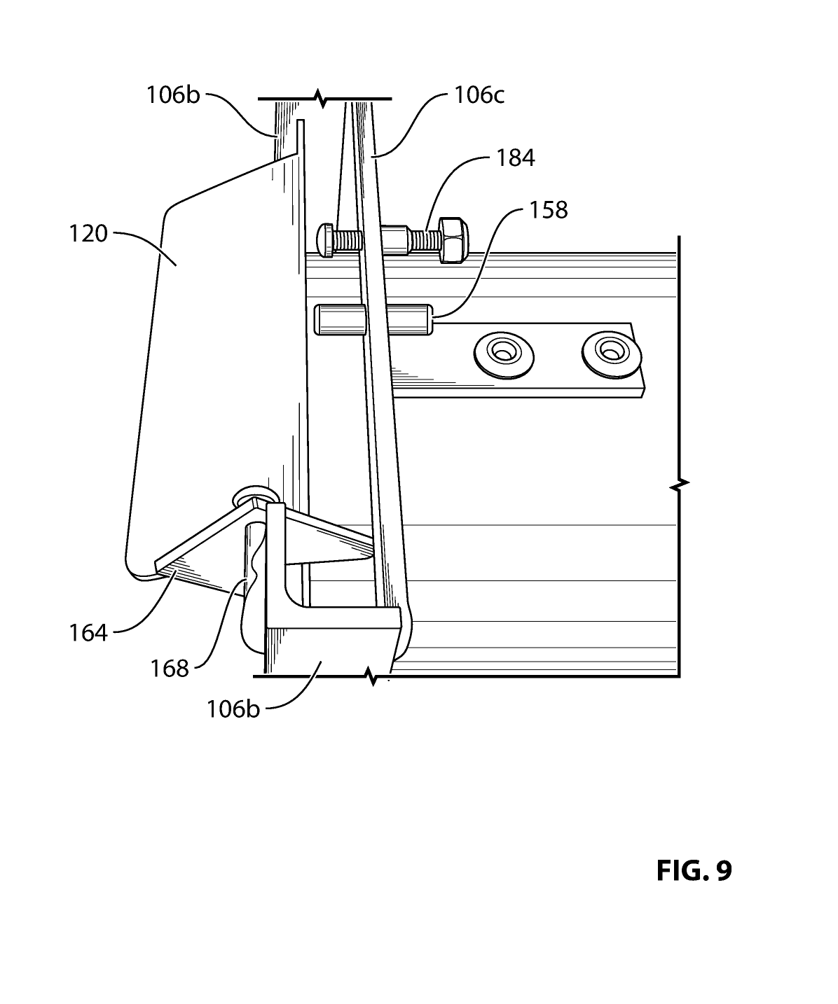

FIG. 9 shows a perspective view of the door 118 installed in the front end 108 of the first tube section 102. In the viewing angle of FIG. 8, the door handle 120 is visible along with the door latch 164 in the neutral position coupled to the door frame side member 106b by door latch support pin 168. The trigger sleeve 158 is attached to the first tubular section 102. An adjustable door pivot 184 is integrated into the door frame upper member 106c and allows the user to adjust the length the door pivot 184 extends toward the door 118 to provide adequate stability to the door 118. This may be useful to mitigate wind shear during capture operations, and may also be utilized to fully block the door 118 from rising and thereby locking the door 118 for transport if required.

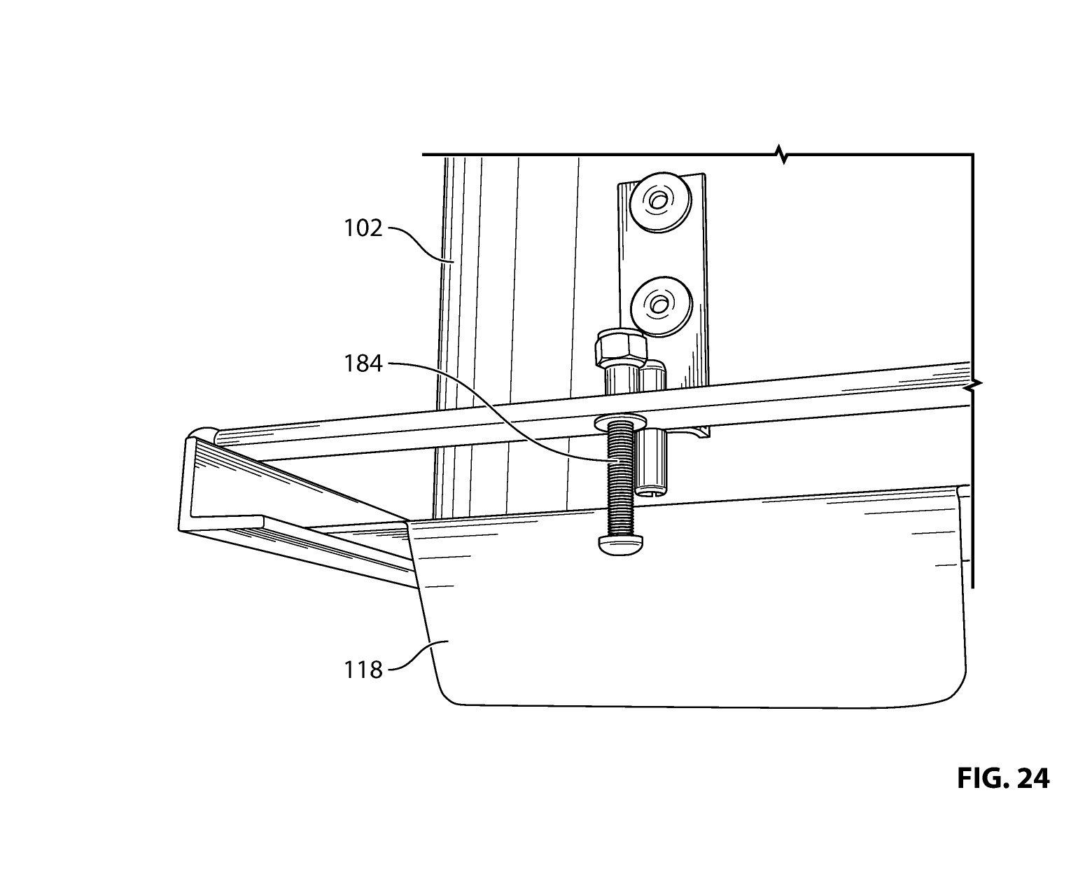

The door pivot 184 in this embodiment is a user adjustable bolt of a suitable distance such as about 1.5 inches that can be extended in order to approach and provide support to the door 118 in the open position, and to protrude over the door 118 in the closed position in order to prevent the door from inadvertently opening if the trap 100 rolls over in the back of a truck during transport, for example. During animal trapping, the user may set the door pivot 184 to approach or abut against the side of the door 118 in the raised position depending on expected wind and vibrations. The adjustable door pivot 184 helps the user prevent false wind triggers or trigger failures given the tendency of the trap door 118 to lean under wind load. During transport, the door pivot 184 may be manually extended over the door 118 by the user to block the door 118 from opening as illustrated in FIG. 24.

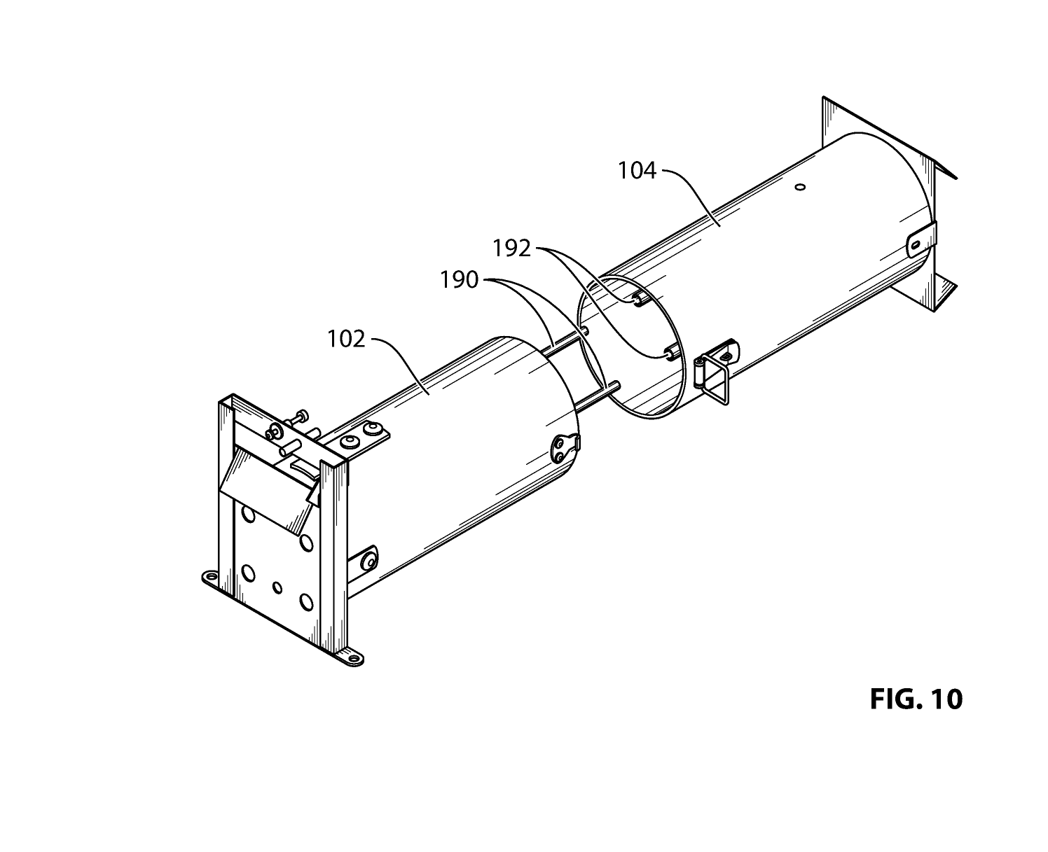

FIG. 10 illustrates the trap 100 of FIG. 1 after the second section 104 has been pulled apart from the first section 102 exposing lateral support pins 190 according to an exemplary embodiment. In this embodiment, support pins 190 extend from the open end 134 of the first section 102 and insert into receptacles 192 on the open end 136 of the second section 104. The support pins 190 provide lateral strength to the connection between the two tube sections 102, 104. Further, in this embodiment, the trigger pin sleeve 158 is integrated into the door frame upper member 106c.

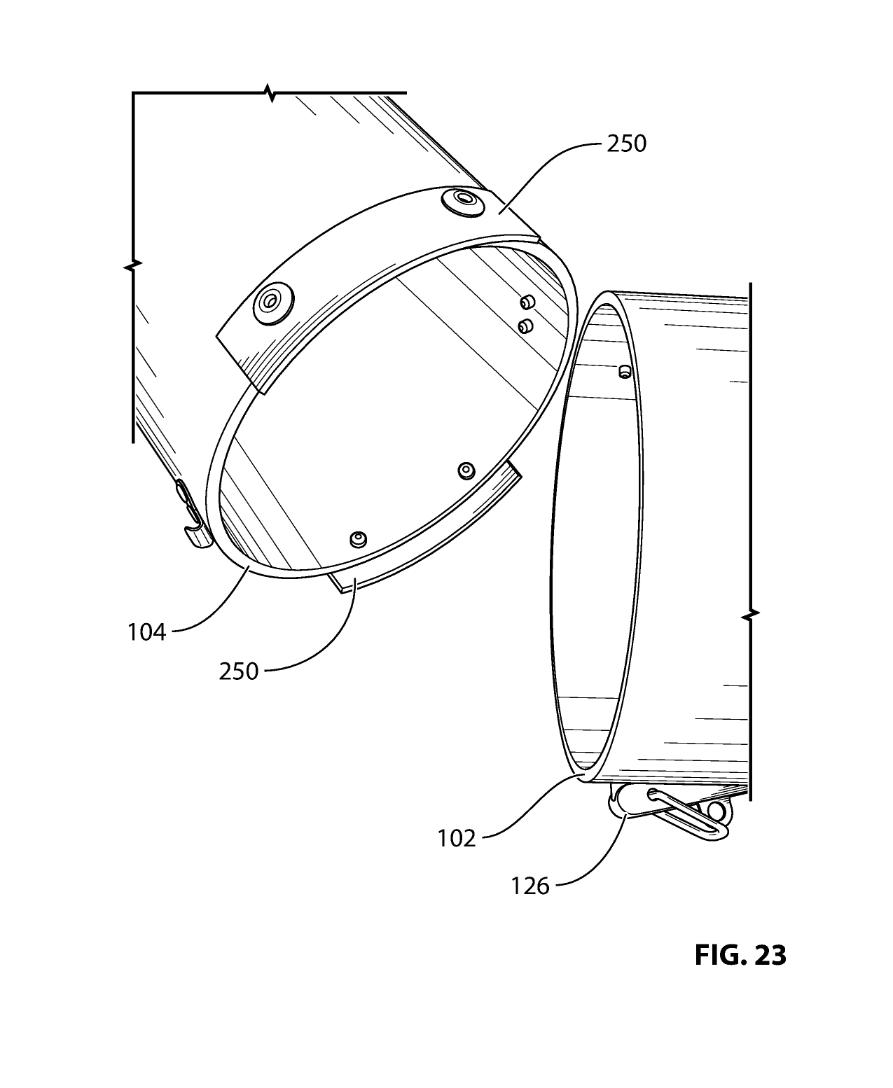

In other embodiments, guides and support brackets may be incorporated into the back and rear ends 134, 136 of the first and second sections 102, 104. For instance, in some embodiments, a tongue and grove design may be employed on the open ends 134, 136 such that these open ends 134, 136 mate with each other. Other mechanical support structures in addition or instead of tongue and grove designs may be employed in a similar manner. For instance, rather than support pins 190, curved metal support pieces such as arches 250 illustrated in FIG. 22 and FIG. 23 may be provided in either or both of the inside and outside of the tube at the top and bottom of the trap 100 on either or both of the open ends 134, 136. As previously mentioned, these supports may be required if the size of the trap 100 is scaled up, as in the case of a larger weight animal. Providing side supports also has ancillary benefit for smaller weight animals because the support pins 190/receptacles 192/arches 250/other support structure are low cost to install and provide extra lateral support. Support pins 190 and/or arches 250 allow flexibility with respect to the side latches 126 and also reduce the support functions and strength requirements of the side latches 126 making the side latches easier to source. Any support pieces 192, 250 or structure helping to guide and support the connection of open ends 134, 136 removes the mechanical dependency from the side latches 126 to the internal support arches and/or structure. Reduced requirements on the side latches 126 allows selection from a larger and cheaper pool of available latches and catches on the market. Likewise, in some embodiments, the side latches 126 may be directly manufactured along with the trap 100 such as by a simple clevis pin fastener to hold the tubular sections 102, 104 closed during animal capture and transport.

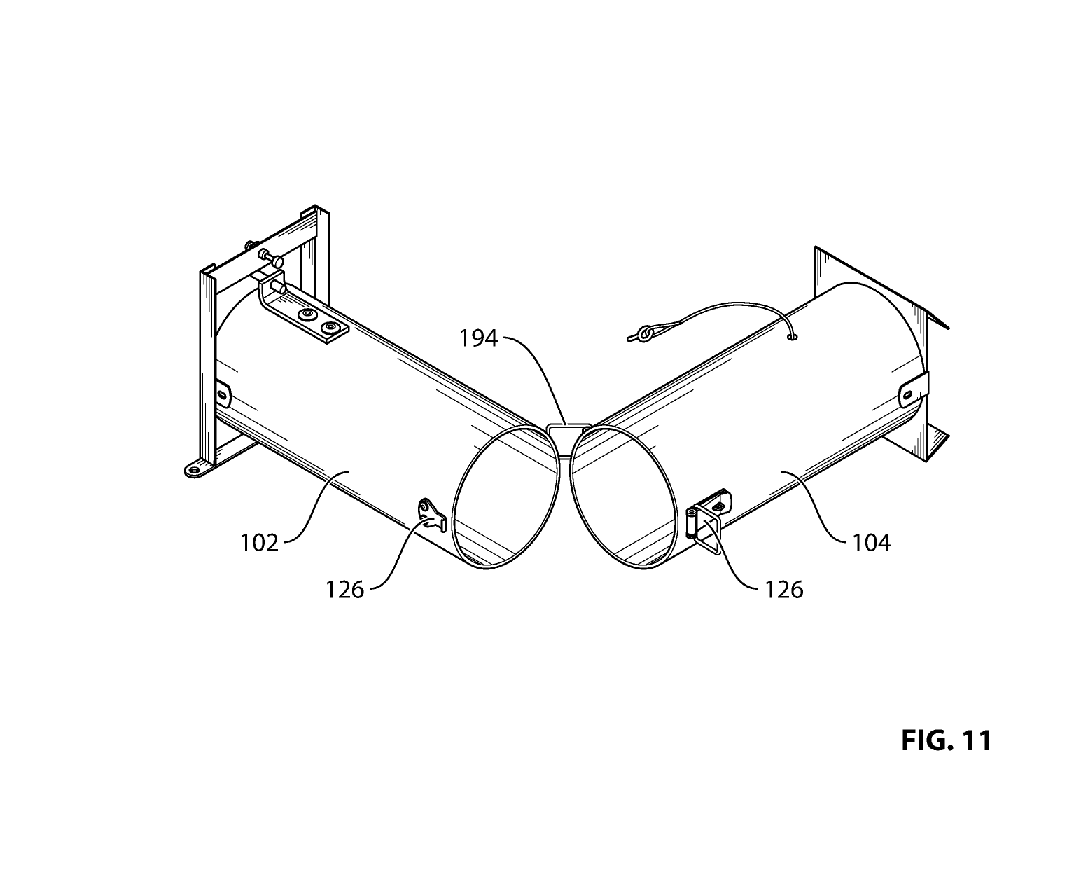

FIG. 11 illustrates the trap 100 of FIG. 1 having a hinge 194 on one side instead of a side latch 126 thereby allowing the trap 100 to split apart in a folding motion.

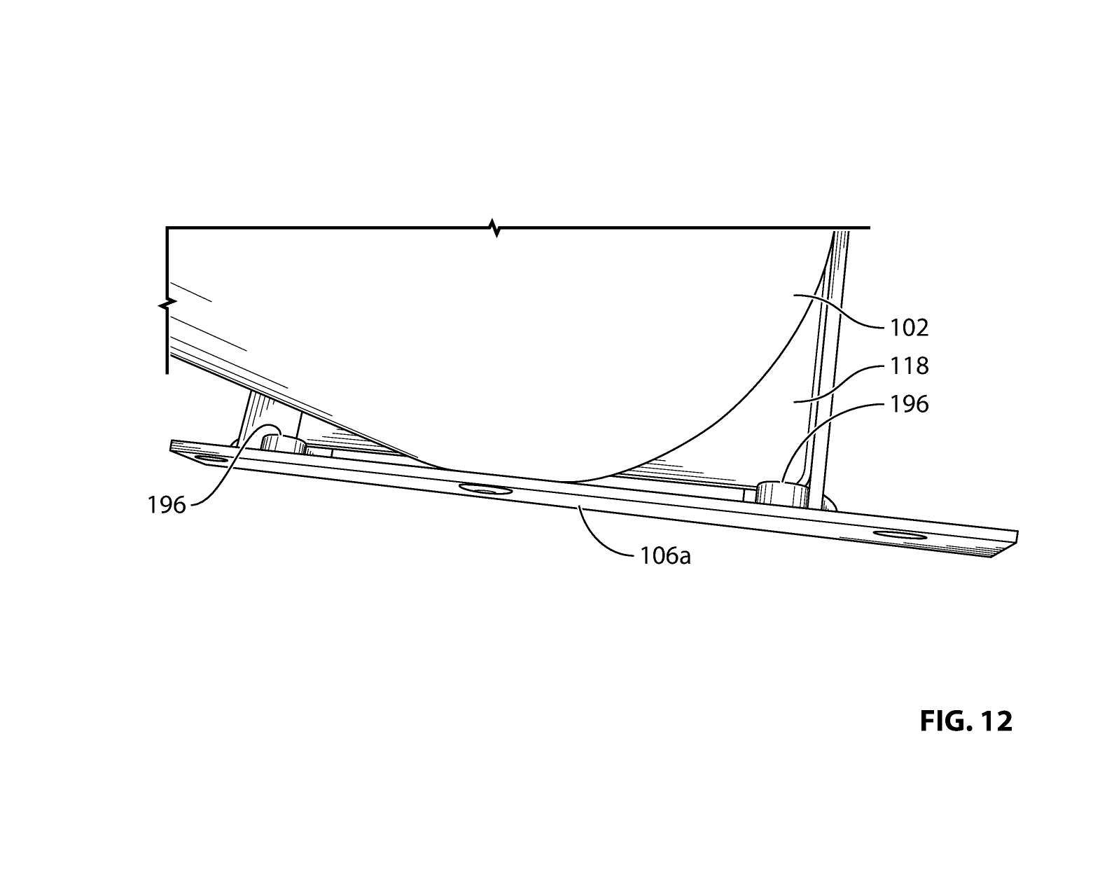

FIG. 12 illustrates door bumpers 196 installed on the door frame bottom member 106a according to an exemplary embodiment. The door bumpers 196 in this embodiment are one or more small rubber/nylon bumpers added to the base frame 106a that attenuate the sound of the door 118 closing and reduce the chance that the animal's tail could be crushed by the falling door 118. One or more bumpers 196 are installed between the point of contact of the bottom edge of the door 118 and the door frame base member 106a. In terms of the noise levels, a rubber bumper 196 may reduce the sound of the metal door 118 hitting the metal bottom frame member 106a by as much as 25 dB. In terms of protecting the animal's tail, the bumper(s) 196 provide at least two benefits. Firstly, bumper 196 reduces the trauma to the animal and thereby is better compliant with animal advocates/pest control companies who identify with a “more humane capture” process. Secondly—and particularly important in the case of skunks—it reduces the likelihood of inadvertent discharge when the animal is frightened when the door 118 falls during the capture process.

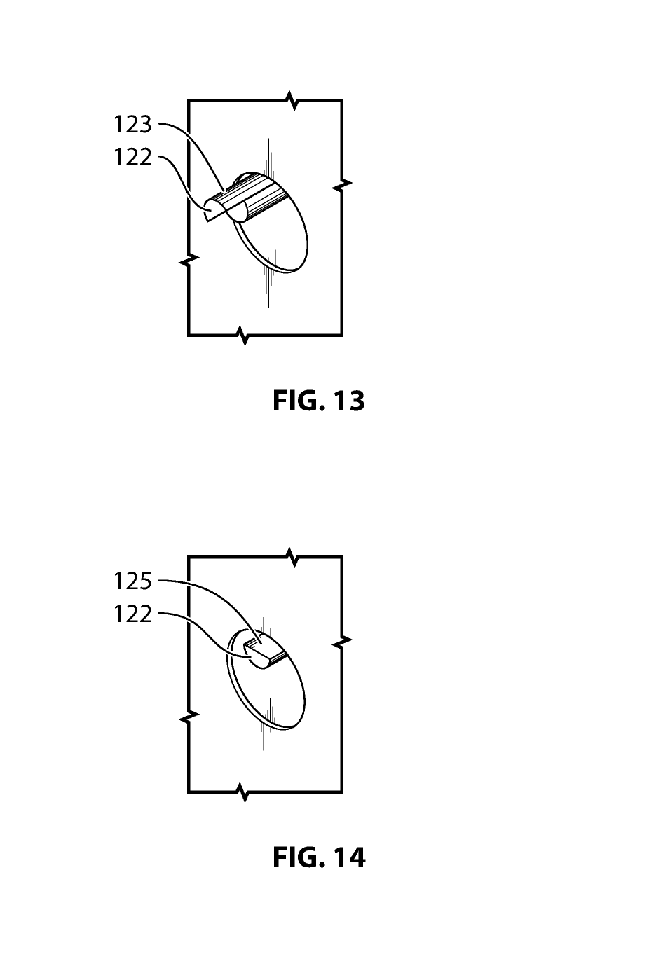

FIG. 13 illustrates a perspective view of the trigger pin 122 being inserted into the trigger pin hole 124 with an orientation to increase sensitivity according to an exemplary embodiment. In this embodiment, the trigger pin 122 has a half moon shaped cross section. When inserted into the trigger pin hole 124 orientated by the user such that the curved side 123 of the trigger pin is facing upwards, there is only a single point of contact against the door 118. This results in less friction when the pin 122 is sliding out from the trigger pin hole 124. For this reason, the sensitivity of the trigger is enhanced because less force is required to remove the trigger pin 122 and cause the door 118 to fall. The trigger pin orientation of FIG. 13 may be useful on calm days without wind or for capturing lighter animals.

FIG. 14 illustrates a perspective view of the trigger pin 122 being inserted into the trigger pin hole 124 with an orientation to decrease sensitivity according to an exemplary embodiment. Again, the trigger pin 122 has a half moon shaped cross section; however, in FIG. 14 the pin 122 is inserted into the trigger pin hole 124 orientated by the user such that the flat side 125 of the trigger pin is facing upwards. In this way, there are at least two points of contact against the door 118. This results in greater friction when the pin 122 is sliding out from the trigger pin hole 124. For this reason, the sensitivity of the trigger is reduced because more force is required to remove the trigger pin 122 and cause the door 118 to fall. The trigger pin orientation of FIG. 14 may be useful on windy or stormy days or for capturing heavier animals.

Operation of the trap 100 is as follows. Bait 182 is positioned within the trap 100 near the back end 142 of the second tube section 104. The trigger line 138 is pull upward by the user in order to insert the trigger pin 122 through the trigger sleeve 158 and into the trigger pin hole 124 in the door 118. The door 118 is thereby held in the open position and the wobble plate 172 is held in the set position ready for an animal to enter the trap 100 and step on the wobble plate 172. When stepped on, the wobble plate 172 pulls down on the trigger line 138 thereby removing the trigger pin 122 from the trigger pine hole 124. The door 118 falls downward and the door latch 164 pivots to the neutral position thereby locking the door shut 118.

The user discovers the trap 100 has triggered and determines that there is an animal captured therein. The user adjusts the door pivot 184 in order to lock the door 118 closed and transports the trap 100 containing the captured animal to a remote location where live-release is desired. The user places the trap on the ground at the release location and attaches the pull rope 156 to the pull rope eyelet 154. The pull rope 156 may be extended away from the trap 100 in the direction of the pull rope eyelet 154, and the trap 100 may be oriented such that directly outside the door 118 are bushes or another area that is likely to be desirable for hiding by the animal. Anchor pins 112 may be inserted into the ground to fix and hold the position of the first tubular section 102. The user adjusts the door pivot 184 in order to allow the door to be opened and undoes the side latch(es) 128 to allow the first and second tubular sections 102, 104 to be separated from one another.

When ready, the user rotates the door latch 164 into the unlocked position and pulls the door 118 up and out of the trap 100 while ensuring the user's body is positioned behind the trap 100 away from the from the front end 108 of the trap 100. After removing the door 118 from the trap 100, the user walks away from the trap in the direction of the pull line 156, and, at a safe distance, the user pulls the pull line 156 in order to separate the second tubular section 104 from the first tubular section 102. With the front end 108 of the trap open and the first and second sections 102, 104 of the trap 100 pulled apart from one another, the animal has nowhere to hide inside the trap 100 without at least part of the animal's body being exposed to the outside air and daylight. With all the opened areas of the trap 100 including the front and back ends 108, 134 of the first tubular section 102 and the front end 136 of the second tubular section 104, the animal is much more likely to immediately leave the area of the trap 100 and seek a safer, less exposed area such as the bushes directly in front of the door 118.

The above described steps of utilizing the trap 100 to catch and release an animal are not restricted to the exact order described, and, in other configurations, described steps may be omitted or other intermediate steps added. For instance, at least three release modes are possible depending on user experience and preference:

a) Door exit—An experienced trapper can open the door 118 and quickly exit from the trap zone. Unlike other traps on the market, the trap 100 of FIG. 1 allows the door latch 164 to be rotated into an unlocked position (see FIG. 4) with just one hand, and the door 118 does not need to be propped open to allow the animal to exit. Instead of propping the door 118 open, the door 118 is simply removed from the trap 100 with the same hand that the was used to raise the door latch 164, and the trapper immediately leaves the trap zone with door 118 in hand. Release through the opened door 118 may be useful for a more controlled release into a confined area such as through a fence hole.

b) Split trap exit—An apprehensive first-time trapper may choose to forgo removal of the door 118 altogether and simply split the trap 100 remotely instead. Such a procedure still offers a 100% increase in exit options for the animal in comparison with option a) above and compared to conventional traps that only have a single door exit. Option b) is the safest release mode because the user is physically far away from the trap 100 when the trap 100 is split into two sections 102, 104 and therefore the user avoids proximity to the released animal.

c) Combined door and split trap exits—The quickest release is achieved by combining modes a) and b) so that animal has three possible exits from which to leave the trap, instead of just one for mode a) and instead of just two as in mode b). In mode c), the user first opens the door 118 and then pulls the second section 104 away from the first section 102 to open up the trap. The open door 118 and open ends 134, 136 greatly expose the animal and leave little area for the animal to hide within the trap 100.

By separating into multiple parts, the trap 100 increases the number of exit routes for the animal to leave from one to three exits. The design allows introducing daylight into the trap 100 at a controlled rate, and encourages the animal to leave immediately as its natural tendency to hide can no longer be satisfied once the trap 100 is split into multiple sections. Additional motivation can be provided at a safe distance by pulling on the cable 156 attached to the trap 100.

As opposed to traditional live-release traps for skunks, some embodiments of the trap 100 disclosed herein enable releasing a skunk from a safe distance of 25+ feet, thereby significantly reducing the risk of being sprayed during live-release. For both skunks and other animals, embodiments of the trap 100 disclosed herein also significantly reduce the fear associated with being close to a wild animal and the medical dangers of being bitten or scratched by the animal during the release process.

In an exemplary embodiment, a two-part animal trap 100 is disclosed. The trap 100 is remotely separable into multiple sections (e.g., the trap 100 may separate in half) under user control so as to encourage rapid, yet controlled, escape of a trapped animal from a safe distance. The trap 100 is a long tube, bisected tangentially and secured by a number of side catches or side latches 126. Larger versions of the trap 100 may include a higher number of side latches 126 for greater support. The trap 100 addresses the issue that the process of releasing a live animal from a traditional single door trap may take up to twelve hours due to a skunk not being willing to exit the confines of a trap until it feels safe. Traps 100 disclosed herein offer three modes of safe release, designed for the apprehensive first-time trapper up to the experienced professional.

Integrated handles 120, 144, anchor holes 110, anchor pins 112 and rear skid plate 152 ensure safe transport of live animal, as well as tangle-free and low friction separation of trap sections 102, 104 while on cluttered, uneven, slippery or angled ground. The anchor holes 110 also function as 1) a way to hang and store the trap 100 when not in use 2) a method by which a user can temporarily attach the trap 100 to the wooden base in a truck bed to eliminate any chance of it rolling over during transport.

An adjustable door pivot 184 reduces false triggers due to wind exposure on trap door. Utilizing a nylon door pivot 184 reduces door friction allowing for increased performance as well as reduced noise from wind vibration that may deter animal entry.

A notched door latch 164 mechanism facilitates single-handed removal of door 118 during the release phase, yet ensures the animal remains secure when trap 100 is picked up by front and rear end handles 120, 144 of the trap 100. Although the description of the door latch 164 above has focused on the W-shaped door latch shown in FIG. 3 and FIG. 4, other shapes of mechanical door latch mechanisms 164 may be employed in a similar manner to achieve the same result of both locking the door closed and allowing the user to unlock the door and do a single-handed release. Other shapes that may be employed for the door latch in other embodiments include squares, circles, or triangles that fall into place above the door to secure it (like in FIG. 4) but that can be rotated into a stable unlocked position (like in FIG. 5) when needed by the user. Notch out areas 166 may be beneficially added to any of the geometric shapes in a similar manner as shown above in FIG. 4 and FIG. 5 to allow the door latch 164 to lock the door closed 118 upon automatic door trigger.

The split-trap design disclosed herein facilitates easy maintenance, repair and cleaning, as well as bait 184 placement as trappers can easily extend their arm into each half of a twelve-inch cylinder 102, 104.

To better prevent the possibility of premature separation of the two sections 102, 104 of the trap 100 resulting in accidental release of the enclosed animal, commercial catches may be used as the side latches 126 to secure the tubular sections 102, 104. Safety lock catches may be used to add a secondary degree of protection to the design. The side latches 126 may ensure the trap 100 stays together even if manufacturing or assembly standards are poor with respect to the allowable gap tolerance between sections 102, 104.

The nylon coated stainless steel trigger cable 138 may hang loose in some embodiments when not in use, or after being triggered. Both the trigger cable 138 and the trigger pin 122 are commonly available parts and are considered consumables in some embodiments. They may be selected to be readily available and replaceable with standard parts. As they do represent a minor storage challenge and a possible tripping hazard for the user, a small storage container may be provided with the trap 100 to safely contain these components when not in use and to store a number of replacement parts. The storage container may be attachable to the trap 100 to ensure the required parts are kept with the trap 100 until needed.

To further reduce initial cost of employing a trap 100 that separates into multiple sections as disclosed herein, existing traps on the market that do not natively support separation may be easily modified to become multi-section traps with separation capabilities. For instance, an exemplary method of manufacturing an animal trap includes customizing and modifying existing trap designs. A single tubular skunk or other animal trap is modified in some embodiments by cutting the tubular trap into two sections 102, 104. Side latches 126 and optional support brackets/arches are installed to allow the user to selectively join and separate the two tubular sections 102, 104. A pull rope eyelet 154 is installed on at least one of the tubular sections 102, 104. In this way, an existing tube trap is easily converted into a tube trap 100 such as illustrated in FIG. 1 that can separate into multiple sections for quicker live-release that enabled by the original tube trap design. The conversion process may be performed by the user themselves after purchase of the original tube trap design, or may be performed at a manufacturing facility such as to convert existing tube trap stock into an improved design. Non-tubular traps on the market may also be modified in a similar way.

The consistent behaviour of the wobble plate 172 reduces bait 182 theft and false triggers, thereby increasing success rates. The simple mechanical design of the wobble plate 172, trigger cable 138, and trigger pin 122 supports easy maintenance and repair, if needed. By utilizing standard and widely available components, these trigger system components 172, 138, 122 may be user serviceable without reliance on proprietary components. The trigger process benefits from an adjustable door pivot 184 that controls the tilt of the door 118 in such a way to prevents door jams and compensate for false triggers due to wind load.

That the trap 100 opens up and splits into multiple sections 102, 104 according to some embodiments facilitates easy cleaning and maintenance. The longer tubular section of the trap 100 as utilized during the capture and transport phases is not a limitation on the maintenance or cleaning phases. Instead, the trap 100 has the ability to separate into two shorter lengths 102, 104, each of which allows for easy access to internal areas. Specifically, the length of each section 102, 104 may be selected to be short enough that an average person's arm can access all components without the aid of tools or special devices.

To facilitate separation and dragging at least the second section 104 across rough ground to open the trap 100, embodiments disclosed herein incorporate two anchor holes 110 at its front door base frame member 106a, as well as a sixty-degree skid or anti-friction plate 152 at its rear (sealed) base end 142 that helps to prevent the second section 104 from getting caught on rocks or other debris when being separated from the first section 102. Together these features secure the front portion 102 of the trap 100 into the ground while providing a mechanism for separating the rear portion 104 when being pulled by a cable 156 or other means.

An inherent challenge with remote mechanical release of smaller animals such as skunks or opossums is a physical limitation: the weight of the animal and trap combined is typically <14 pounds. This weight alone may be insufficient to secure the trap 100 in place while utilizing a cord or other pull cable 156 to pull apart the first and second tubular sections 102, 104 from a safe distance. While it is possible, doing so may require a quick jerking motion. In the case of skunks, quick jerking motions may result in an animal that sprays in defence or fear. To solve this problem, anchor pins 112 may be employed to secure the first tubular section 102 to the ground via anchor holes 110. The skid plate 152 on the second tubular section 152 further facilitates movement and prevents snagging on the ground. With these features, a user may slowly pull the second tubular section 104 away from the first tubular section 102 in a gentle manner thereby reducing the chances of scaring and causing the skunk to spray during the release process.

An exemplary benefit of some embodiments is the ease of access for cleaning and maintenance of the trap 100. Cleaning is typically addressed by trap owners using a garden hose to clean the trap, or occasionally by making a rear plate removable to facilitate cleaning. As traps are typically 24-30 inches long, it can be difficult to reach to the back of the trap to clean out debris. Debris that gets into mechanisms or impedes unreliable electronics is difficult to access. While there are two-door traps on the market, these still lack the ease of access of a trap 100 such as disclosed above in FIG. 1 that splits into two pieces. A common problem with plate traps is that the inevitable “sticky mess” left by cooked bait inside the trap clogs the mechanisms, leading to future bait theft and lower success rates. This problem is exacerbated by the difficulty of accessing all components of the trap for thorough cleaning. Embodiments of the trap 100 disclosed herein solve these problems by allowing the long tubular trap to be separated into multiple sections 102, 104 by the user. Since these tubular sections are open ended and of shorter individual length, cleaning of each section and access into even the furthest reaches of each section during maintenance is beneficially facilitated.

Access to the rear 142 of the trap 100 may be beneficial because it allows for easy placement of bait 182, as well as post-capture cleanout—skunks often void themselves when confined. Most garden hose pressure (<60 psi) is insufficient to clean adequately when needing to spray into tube traps on the market that are not separable into multiple sections 102, 104. Higher pressures can damage internal trap components. In an advantageous embodiment, the ability of the trap 100 to split into smaller sections 102, 104 allows easy access to the rear end 142 of the trap. Cleaning can therefore be done without needing to rely solely on water pressure. Clean traps are a concern to DIYers in residential settings, as skunk feces are known to carry five or more diseases—some of which can be transferred to humans or family pets.

In an advantageous embodiment, the curved wobble plate 172 design increases the surface area of the trip plate within a curved container so as to maximize likelihood of animal contact. The wobble plate 172 has a single pivot point 174 that forces the animal's weight to the centre of the plate 172, thereby maximizing downward force and travel distance on the trigger line cable 138 to pull the trigger pin 122 and release the trap door 118, thereby capturing the animal. This is especially effective on juvenile animals that are traditionally harder to capture due to their smaller mass and ability to manoeuvre around obstacles.

An exemplary benefit of the curved wobble plate 172 of FIG. 6 and FIG. 7 according to some embodiments is the simplicity of the design. Elaborate alternatives are possible for tube traps, but mechanical complexity is an issue when one component gets hung up on another due to bait or debris trapped in a mechanism. As components wear the frequency of these failures increases. Overly complicated mechanical triggers also tend to be weight-specific to the animal and the ridged components necessary would prohibit the separation of the trap into two halves. An adage in the trapping industry is “keep trigger mechanisms simple and self-repairable.” The reliability of “easy set” traps with spring-based triggers can vary significantly with age, weather, use, etc. This said, although the above description has focused on a curved wobble plate 172, other types of trigger plates and trigger mechanisms may be employed in other embodiments. Other approaches include elaborate trigger designs, built specifically for tube traps. Yet other solutions involve abandoning the trip plate altogether and relying on proprietary solutions such as a 330 Conibear Trigger originally intended for use in kill traps.

In some embodiments, one-handed opening of the door 118 is facilitated through the door latch 164 on the top frame member 106c and/or side frame member 106b of the door frame 106. As illustrated in FIG. 4 and FIG. 5, the door latch 164 flips up in an unlocked position (see FIG. 5) and stays in place in the unlocked position. The geometry of the door latch 164 is such that it stays in place in the unlocked position so that the user only needs one hand to remove the door 118 from the trap 100 during the release process.

Electronic mechanisms such as triggers, capture notifications and alerts, and release mechanisms, if desired may also be utilized with any of the above embodiments. For instance, in other embodiments, electronics, specifically micro switches, passive IR sensors, ultrasonic transducers, wiring harnesses, electronic sensors such as phototransistors, LASCRs, solenoids or servos may be utilized to trigger and close the trap door 118. Likewise, any of these electronics may also be utilized to separate the first tubular section 102 from the second tubular section 104, or to open up any of the side panels 216 of the trap 100 (see FIG. 16 and FIG. 17). Electronics components may be sourced from the remote control (RC) or robotics industries. If not rated for outdoor use, weather proofing may be incorporated into the design as required. Solar panels may provide electricity from solar power and may automatically charge batteries as it is often necessary to leave traps 100 out for weeks before capturing an animal. Solar power may help prevent battery draw and depletion from becoming a point of failure.

Beneficially, embodiments of the present invention anticipate that many of the components of the trap 10 may be user replaceable parts such as trigger line cables 138. It is not uncommon for an animal within the trap 100 to chew threw trigger cables 138. The slip rings 180 allow for easy replacement of new trigger lines 138 as needed.

According to an exemplary embodiment, an animal trap 100 contains multiple tubular sections 102, 104 connected with side latches 126 to form a single hollow structure. A trigger mechanism includes a curved wobble plate 172 with curvature matching a rear tube section 104. When stepped on by an animal, the curved wobble 172 plate pulls a trigger pin 122 from a trap door 118 causing the door 118 to fall to the ground. A rotatable door latch 164 then moves into a locked position preventing the door 118 from opening. After determining the trap to contain an animal, a trapper transports the trap to a remote location. A pull rope 156 is connected to at least one of the sections 102, 104, and another section 102, 104 may be anchored to the ground using anchor pins 112. The trapper undoes the side latches 126 and rotates the door latch 164 into an unlocked position. The trapper removes the door 118 from the trap 100 and pulls the trap sections 102, 104 apart thereby releasing the animal from the trap 100.

Although the invention has been described in connection with preferred embodiments, it should be understood that various modifications, additions and alterations may be made to the invention by one skilled in the art without departing from the spirit and scope of the invention. For example, although the above-description has focused the capture and live-release of skunks, embodiments of the trap 100 and associated capture/release methods and modes disclosed herein are also applicable to other types of animals. For instance, the trap 100 dimensions may be scaled appropriately for larger animals such as raccoons. In another exemplary modification, instead of two or more side latches 126 to split the trap 100 into multiple sections 102, 104, one or more side latch(es) 126 may be combined with a side hinge 194 on the other side as illustrated in FIG. 11. In this way, instead of pulling the multiple sections 102, 104 of the trap completely separate and unconnected to one another, the sections 102, 104 may fold away from each other at the hinge 194. In yet another exemplary modification, the end plate 144 may be replaced with another door 118. In the two door 118 version, the trigger mechanism may likewise be modified in order to support automatically and simultaneously closing both doors 118 after entry of the animal into the trap 100. Although flexible wire is utilized as the trigger line 138 in the above description, the trigger line 138 may also be a rigid cable. Rather than utilizing standardized zinc eye bolts for the rope eyelet 154, a dock cleat for wrapping the pull cord 156 may be utilized in a similar manner in other embodiments.

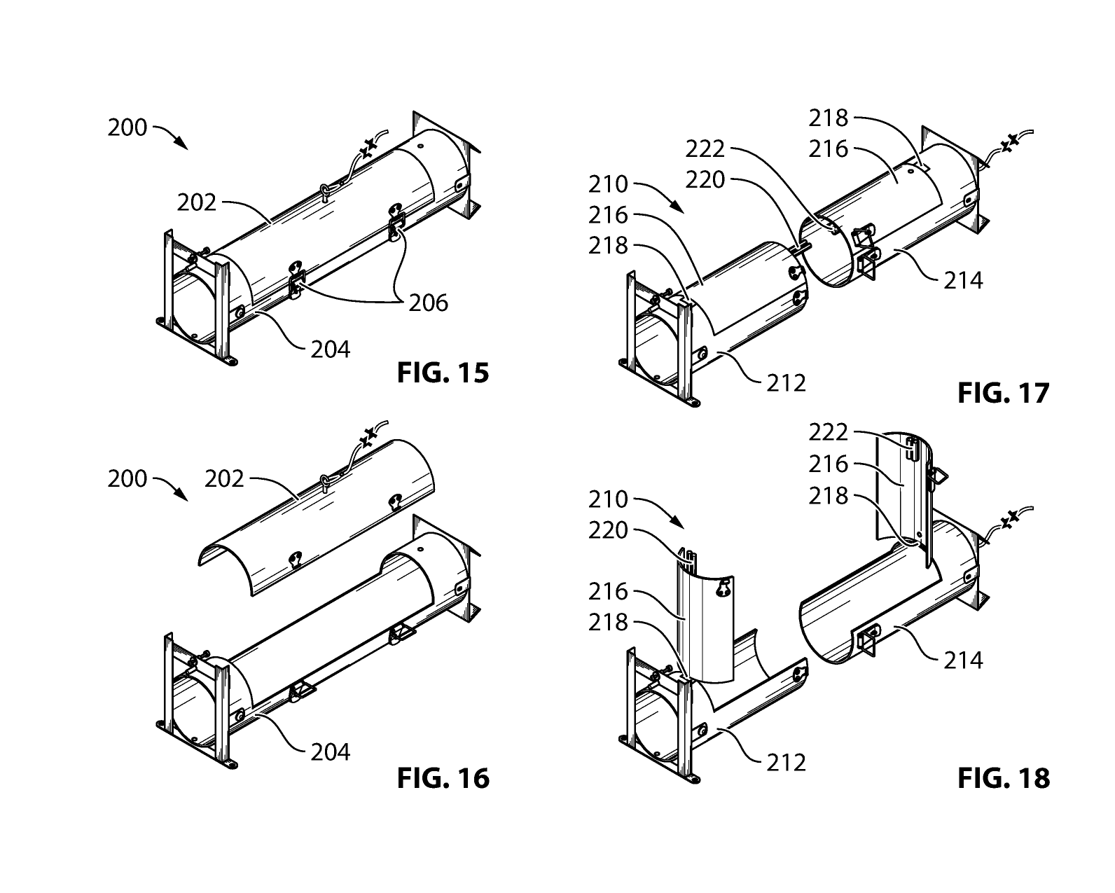

Although the above described embodiments have focused on a trap 100 that splits vertically between two substantially equal length sections 102, 104, this is not the only way to split the trap open and other embodiments and features are possible in a similar manner. FIG. 15 to FIG. 21 illustrate perspective views of traps 100 with split, separation, and opening capabilities to facilitate quick live release according to other embodiments.

FIG. 15 illustrates an animal trap 200 that separates horizontally according to an exemplary embodiment. In this embodiment, the trap 200 includes a lid tube section 202 that can be separated from a base tube section 204. An eyelet 206 is attached to the lid tube section 102 so that a remote user can pull the lid tube section 102 away thereby opening up the trap 200. Side latches 206 secure the lid tube section 102 to the base tube section 104 for capture and transport.

FIG. 16 illustrates the animal trap 200 of FIG. 15 after the user has pulled away the lid section 202. The skunk or other animal within the trap is now full exposed to daylight and can simple climb out of the trap 200 in any direction.

FIG. 17 illustrates an animal trap 210 that splits in two and also includes hinged top sections 216 that automatically open after the trap 210 is split in two according to an exemplary embodiment. In this embodiment, the trap 210 is generally similar to that described in FIG. 1; however, both the first and second sections 212, 214 of the trap 210 now include hinged top panel sections 216. Each of these panel sections 216 has a spring loaded hinge 218 that is biased to always attempt to open the top panel sections 216. A panel support pin 220 mates with a receptacle bracket 222 when the first section 212 is joined with the second section 214 and prevent the panels sections 216 from opening as long as the first section 212 stays joined with the second section 214.

FIG. 18 illustrates the animal trap 210 of FIG. 17 with the panel sections 216 opened. Upon the user pulling these two sections 212, 214 apart from each other, the support pin 220 is removed from the receptacle bracket 222 and the top panels open and expose the animal inside the trap to daylight.

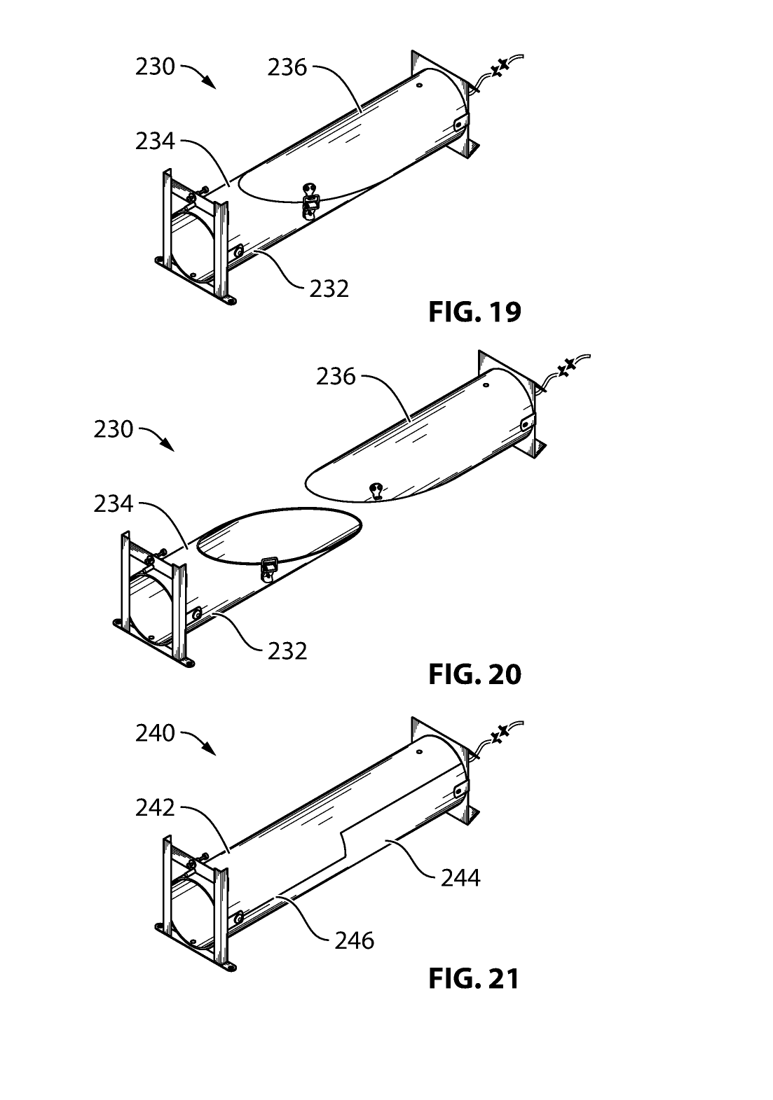

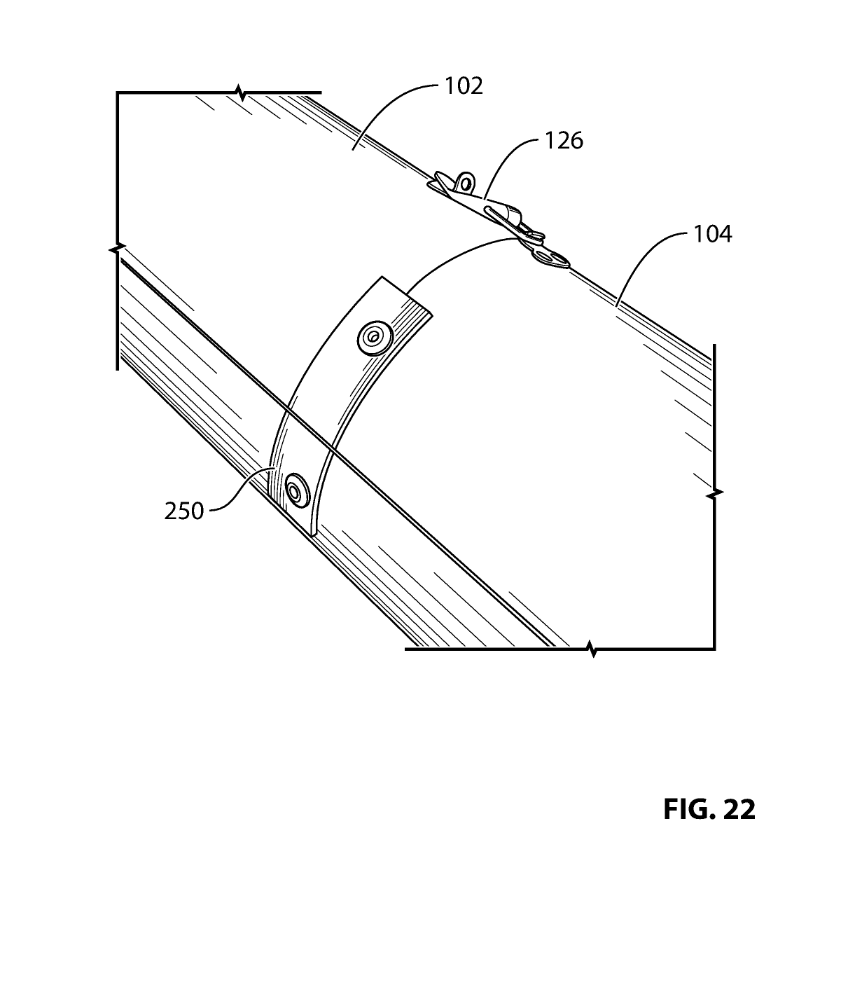

FIG. 19 illustrates an animal trap 230 that splits into multiple sections 234, 236 and is manufactured with a diagonal split line 232 according to an exemplary embodiment. FIG. 20 illustrates the animal trap 230 of FIG. 19 after the first and second sections 234, 236 are pulled apart from one another. Likewise, FIG. 21 illustrates an animal trap that splits into two sections 242, 244 with a polygon split line 246 according to another exemplary embodiment.

Furthermore, although the above examples have focused on splitting the trap 100 into two sections 102, 104, the invention is not limited to only two sections 102, 104. In other embodiments, the trap 100 may be formed by combining any number of sections 102, 104 in a similar manner. Each of the sections may include a pull rope eyelet 154 or integrated pull rope 156 enabling the user to remotely pull the sections apart from one another during live-release. Likewise, side latches 126 along with optional support structure 190, 192, 250 can be utilized to join the open ends 134, 136 of each section 102, 104 during capture and transport. Any number of sections 102, 104 may be daisy chained together to form a single, combined hollow section that forms the body of trap 100 during the capture and transport phases.

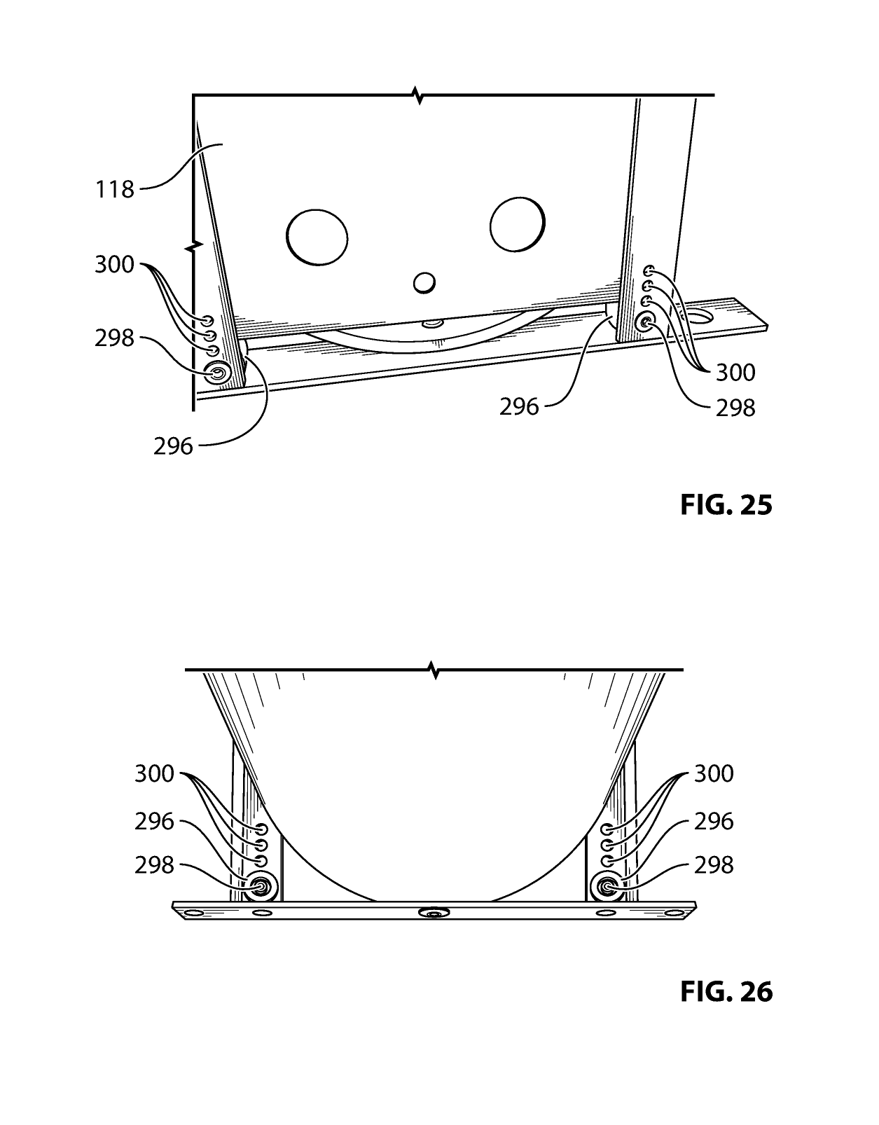

Although the door bumpers 196 of FIG. 12 are installed on the door frame bottom member 106a, other configurations are also possible. For instance, FIG. 25 is a forward-facing view of an animal trap illustrating door bumpers 296 installed on the door frame side members 106b according to an exemplary embodiment. FIG. 26 is a rearward-facing view of the animal trap of FIG. 25 illustrating the door bumpers 296 installed on the door frame side members 106b. In this embodiment, the door bumpers 296 are circular rubber ring bumpers 296 that include embedded metal washer and are held in place utilizing a rivet or screw 298. The rivets or screws 298 are positioned on the bottom portion of the opposing sides of the door frame side members 106b via through-holes. To accommodate different animal types and tail thicknesses, the door side members 106b may be manufactured with a plurality of through-holes 300 allowing the user to set the desired door gap distance D1 in different modes of operation. In other embodiments, rather than a plurality of separate through-holes 300, an elongated oval gap may extend from the bottom of the side members 106 upwards to a mid section of the side members 106 thereby allowing the height of the side bumpers 296 to be adjusted by the user. For instance, the user may loosen the rivet or screw 298, slide the bumper 298 within the elongated oval gap to set the desired D1 door height, and then tighten the rivet or screw 298 to hold the bumper at that position. Both side bumpers 296 may be adjusted to be the same height by the user thereby allowing the user fine control over setting the D1 distance.

A tertiary safeguard such as a user-removable bracket secured to both the first and second sections 102, 104 by screws may be added in other embodiments to secure the multiple sections 102, 104 together in addition to the side latches 126. Having a secondary securing means may be beneficial to ensure the trap 100 stays together as a single hollow section during transit.

Two-handed-release may make retreat a bit more complicated for the user, and may create the possibility that the animal could bolt and get stuck in the partially opened door 118 while the user is in the process of releasing the animal. For this reason, the door latch 164 described above supports one-handed-release; however, in some embodiments, two-handed-release may also be possible or required depending on application requirements.

Traps 100 according to different embodiments can be manufactured using different materials according to availability and desired characteristics. For instance, commonly available and/or standardized materials such as irrigation pipe may be utilized for the tubular sections 102, 104. Likewise, angle iron may be utilized for door frames 106 in some embodiments. The side latches 126 may be implemented by commonly available chest or toolbox latches.

Electronic alerts may also be provided upon predetermined conditions. For instance, an “executive version” of trap 100 may include sensors, power supply, wireless transmitter and/or receiver, and one or more processors that execute software from a memory in order to send one or more messages. The processors may be configured by the software to send a wireless alert to the trapper remotely when an animal is captured. Likewise, an alert may also be sent by the processors upon the animal having exited from the trap during the release process.

The trap 100 may also be disposable in some embodiments and cheap enough that it can be abandoned at minimal financial impact to trappers.

Functions of single modules may be separated into multiple units, or the functions of multiple modules may be combined into a single unit. For example, although the door frame 106 and the first section 102 are illustrated and described as being separate units in the above example, these components 106, 102 may be combined into a single integral unit in other embodiments. Likewise, all combinations and permutations of the above described features and embodiments may be utilized in conjunction with the invention.

What is claimed is:

1. An animal trap comprising:
a first hollow structural section having a door and a first open end;
a second hollow structural section having a second open end; and
a side latch on at least one of the first hollow structural section and the second hollow structural section, the side latch operable by a user to selectively secure the first open end of the first hollow structural section to the second open end of the second hollow structural section;
wherein, when secured together by the side latch, the first hollow structural section and the second hollow structural section are joined and form a single hollow structure;
the door is movable between an open position allowing an animal to enter the single hollow structure through the door, and a closed position preventing the animal from exiting the single hollow structure through the door;
the door is automatically triggered to move from the open position to the closed position after the animal has entered the single hollow structure; and
when not secured together by the side latch, the first open end and the second open end may be pulled apart from one another thereby allowing the animal to exit the animal trap through one of the first and second open ends.

2. The animal trap of claim 1, further comprising:
a door latch;
wherein the door latch is movable by the user into a first position to allow the door to open; and
the door latch automatically moves into a second position after the door has closed, the second position preventing the door from being opened without the user first moving the door latch back into the first position.

3. The animal trap of claim 1, further comprising:
a trigger plate,
a trigger line coupled to the trigger plate, and
a trigger pin coupled to the trigger line;
wherein the trigger pin holds the door in the open position until pressure on the trigger plate pulls the trigger line and prevents the trigger pin from holding the door in the open position, gravity thereafter pulling the door into the closed position.

4. The animal trap of claim 3, wherein the trigger plate is coupled to one of the first hollow structural section and the second hollow structural section at a single pivot point.

5. The animal trap of claim 3, wherein the first hollow structural section and the second hollow structural section are tubular sections.

6. The animal trap of claim 5, wherein the trigger plate is a curved wobble plate with curvature matching a curvature of at least one of the first hollow structural section and the second hollow structural section.

7. The animal trap of claim 1, further comprising:
a door latch coupled to at least one of the door and the first hollow structural section; and
the door latch is movable into at least two positions, a first position preventing the door from opening, and a second position allowing the door to open.

8. The animal trap of claim 7, wherein:
the door latch is coupled to a frame of the door via a support pin; and
the door latch is rotatable around the support pin between the first position and the second position.

9. The animal trap of claim 1, further comprising at least one carry handle.

10. The animal trap of claim 1, further comprising a plate coupled to a second end of the second hollow structural section preventing the animal from exiting the second hollow structural section from the second end.

11. The animal trap of claim 10, wherein the plate includes a carry handle.

12. The animal trap of claim 1, further comprising locks on the side latch such that the side latch stays in the closed position.

13. The animal trap of claim 1, further comprising one or more anchor pin holes on at least one of the first hollow structural section and the second hollow structural section.

14. The animal trap of claim 13, further comprising:
one or more anchor pins installed in the anchor pin holes on only one of the first hollow structural section and the second hollow structural section;
wherein a pull line is coupled to an opposite one of the first hollow structural section and the second hollow structural section than the one or more anchor pins.

15. The animal trap of claim 1, further comprising a pull line eyelet coupled to an outside of at least one of the first hollow structural section and the second hollow structural section.

16. The animal trap of claim 15, further comprising the pull line coupled to the pull line eyelet.

17. A method of relocating an animal, the method comprising:
positioning bait within at least one hollow section of an animal trap;
connecting at least two hollow sections of a trap together in series to form a single hollow section;
setting a door in an open position thereby allow the animal to enter the trap at a first location;
returning to the trap at a later time and determining the animal is captured within the trap;
transporting the trap containing the animal to a second location for release; and
during a release process, separating the at least two hollow sections of the trap apart from one another.

18. The method of claim 17, further comprising setting a trigger pin into a trigger pin hole on the door of the trap, the trigger pin thereby holding the door in the open position, wherein the trigger pin is coupled to a trigger pine line, and the trigger pin line is coupled to a wobble plate held by tension on the trigger pin line in a set position ready for the animal to enter the trap and step on the wobble plate, the wobble plate pulling down on the trigger line thereby removing the trigger pin from the trigger pine hole, the door thereafter falling downward and the door latch pivoting to a neutral position thereby locking the door shut.

19. The method of claim 17, further comprising adjusting a door pivot in order to lock the door closed after discovering the animal is captured within the trap.

20. The method of claim 17, further comprising inserting anchor pins through anchor pin holes on one of the hollow sections of the trap into a ground surface at the second location prior to separating the trap into multiple sections.
